(19) United States
(12) Patent Application Publication
(10) Pub. No.: US 2015/0222753 A1
(43) Pub. Date: Aug. 6, 2015

(54) Method for Handling a Call from a Calling Subscriber Towards a Called Subscriber

(71) Applicant: Rogier August Caspar Joseph Noldus, Goirle (NL)

(72) Inventor: Rogier August Caspar Joseph Noldus, Goirle (NL)

(73) Assignee: TELEFONAKTIEBOLAGET L M ERICSSON (publ), Stockholm (SE)

(21) Appl. No.: 14/427,447

(22) PCT Filed: Sep. 12, 2012
(86) PCT No.: PCT/EP2012/067846

§ 371 Date: Mar. 20, 2015

(51) Int. Cl. H04M 3/53; H04M 3/533; H04M 3/537

(52) U.S. Cl. CPC H04M 3/53; H04M 3/537; H04M 3/533

(57) ABSTRACT

Method, telephony server and message recording system for handling a call from a calling subscriber towards a called subscriber associated with a telephony server in a communications network. When the call is not answered by a user equipment of the called subscriber the telephony server establishes a media connection between the calling subscriber and the message recording system. The telephony server controls a recording process of a message by the message recording system. The telephony server receives, from the message recording system, a reference to the recorded message.

### TECHNICAL FIELD

The invention relates to handling a call from a calling subscriber towards a called subscriber in a communications network. More specifically, the invention relates to message recording, such as voicemail recording.

### BACKGROUND

When a calling subscriber establishes a call to a called subscriber in a communications network, a telephony server acts as the functional component in the communications network that offers basic telephony for users of that network. For example:
For a Global System for Mobile communications (GSM) or third Generation (3G) network, the (Gateway) Mobile Switching Centre (MSC) forms the telephony server;
For an Internet Protocol Multimedia Subsystem (IMS) network with Multimedia Telephony (MMTel), jointly also referred to as MMTel network, the MMTel application server (MMTel-AS) forms the telephony server;
Non-IMS Internet Protocol (IP) communication networks typically have a system component called ‘Call server’; a Call server is a functional combination of entities like Registrar, Session Initiation Protocol (SIP) server, and Application server. An example is Broadworks (supplied by Broadsoft).

When the calling subscriber tries to call a called subscriber, via the telephony server of the called subscriber, such call is not always answered by a user equipment of the called subscriber. It is for instance possible that the called subscriber is engaged in a previously established call, or is not reachable (e.g. has the user equipment switched off). When the call from the calling subscriber towards the called subscriber is not answered, the calling subscriber may be connected to a voicemail system.

FIG. 1 depicts a dilemma resulting from prior art network deployment. The subscriber has two service profiles: one basic telephony service profile (in the Home Subscriber Server (HSS)) and a voicemail service profile (in the voicemail system). The subscriber has to administer his/her telephony service profile in two places:

1) in the MMTel-AS: the basic telephony service profile is maintained in the MMTel-AS, which uses the HSS as permanent (transparent) data storage. Self-administration of the telephony service by the subscriber is done through Extended Markup Language (XML) configuration access protocol (XCAP) signalling between a terminal of the subscriber and the MMTel-AS, via XCAP aggregation proxy (AP).
2) in the voicemail system, for the voicemail service; the subscriber typically uses Dual tone multi frequency (DTMF) to set his/her voicemail service profile; DTMF provides a limited control capability.

This dual service profile hampers the provisioning and administration of a subscriber service that spans basic telephony service and voicemail deposit.

Further, this deployment makes it difficult to provide more versatility and/or additional options or services for the user of the communications network.

### SUMMARY

It is an object of the invention to at least diminish the above disadvantages.

Thereto, is provided a method for handling a call from a calling subscriber towards a called subscriber associated with a telephony server in a communications network. When the call is not answered by a user equipment of the called subscriber or user equipment of a person associated with the called subscriber, the telephony server establishes a media connection between the calling subscriber and a message recording system. The telephony server controls a recording process of a message by the message recording system. The telephony server receives, from the message recording system a reference to the recorded message.

Hence, the telephony server retains control over the call while the message recording system records the message. This allows interaction between the telephony server and the message recording system during recording of the message. This allows for the basic telephony service profile of the called subscriber to also include the profile for the message recording service, allowing for easier self-administration by the called subscriber.

The invention also relates to a telephony server for handling a call from a calling subscriber towards a called subscriber associated with the telephony server in a communications network. The telephony server includes a determination unit arranged for determining whether the call is answered by a user equipment of the called subscriber. The telephony server further includes a connection unit arranged for, when the determination unit has determined that the call has not been answered by a user equipment, establishing a media connection between the calling subscriber and a message recording system. The telephony server further includes a control unit arranged for controlling a recording process of a message by the message recording system. The telephony server further includes a receiving unit arranged for receiving from the message recording system a reference to the recorded message.

The invention also relates to a message recording system for use in a communications network. The message recording system includes a communications unit arranged for establishing a media connection with a subscriber, a receiving unit arranged for receiving control instructions from a telephony server. The message recording system further includes a recording unit arranged for recording a message, a storing unit arranged for storing the message in a database associated with the message recording system, a processing unit arranged for processing the control instructions, and controlling the recording unit accordingly, and a transmission unit arranged for transmitting to the telephony server a reference to the recorded message.

The reference to the recorded message then can include a storage location of the message in the database. This allows for, e.g. centralised, storage of recorded messages with easy access to the messages for the telephony server.

The invention also relates to a telephony server system including the telephony server and the message recording system.

The step of controlling the recording process can include one or more of:

instructing the message recording system to play an announcement, e.g. prior to recording a message;
instructing the message recording system to collect non-voice input from the calling subscriber, e.g. pressing a digit on the keypad for selecting a menu option;
instructing the message recording system to initiate or accept in-call media re-negotiation to the calling subscriber.
   It will be appreciated that this allows for more versatility and/or additional options or services for the user of the communications network.

It is noted that it is known methodology to co-locate a voicemail system with a basic telephony service on the same hardware platform. Having the voicemail service deployed on the same platform as the telephony service does not constitute integration, however. Such voicemail service works independent of the telephony service and vice versa.

It will be appreciated that the call can remain unanswered by the user equipment of the called subscriber by several causes. These causes include the called subscriber being engaged in a previously established call or otherwise busy, the called subscriber not being reachable (e.g. because the user equipment is switched off), the called subscriber not answering the call, the called subscriber having set his/her profile to ‘connect all incoming calls to message recording system’, or the telephony server having a functional connection with an enterprise network, e.g. Outlook (Microsoft Exchange server), and determining through this connection that the called subscriber currently can not accept the call.

In an embodiment, the communications network is an Internet Protocol, IP, based communications network. Optionally, the called subscriber is a Multimedia Telephony (MMTel) subscriber, the communications network is an IP Multimedia Subsystem (IMS) communications network, the telephony server is an MMTel Application Server (MMTel-AS), and the message recording system is a Media Resource Function, MRF. Then, establishing the media connection between the calling subscriber and the message recording system includes one of
sending, by the MMTel-AS, a Session Initiation Protocol (SIP) Invite request relating to the call to the MRF, and
controlling, by the MMTel-AS, media resources in the MRF through H.248 signalling.

The step of receiving the reference to the recorded message then includes receiving, from the MRF, a reference to a storage location of the recorded message in a database.

Optionally, the database is a Home Subscriber Server (HSS) or Centralized User Database (CUDB).

If the message recording system is formed by an MRF, the step of establishing the media connection can include sending the SIP Invite request to a Media Resource Function Controller (MRFC). The step of controlling the recording process then includes providing instructions to a Media Resource Function Processor (MRFP) via the MRFC, for establishing a user plane connection between the calling subscriber and the MRFP. The control plane connection between the calling subscriber and the telephony server remains. The method then further includes storing, by the MRFP, the recorded message in the database. The step of receiving the reference to the recorded message then includes receiving, by the MMTel-AS, the reference to the storage location from the MRFP via the MRFC. Communication between the calling subscriber and the message recording system, via the MMTel-AS, can include Internet Engineering Taskforce (IETF) standard SIP signalling for Session Description Protocol (SDP) offer-answer exchange between the calling subscriber and the MRFC.

Alternatively, the MMTel-AS can control media resources in the MRFP directly, without involving the MRFC. Then, the step of controlling the recording process includes providing instructions to the MRFP controlled by the MMTel-AS for establishing a user plane connection between the calling subscriber and the MRFP. The step of receiving the reference to the recorded message then includes receiving, by the MMTel-AS, the reference to the storage location from the MRFP.

Optionally, the recorded message is stored when the calling subscriber releases the call, e.g. when the SIP session from the MMTel-AS to the MRFC is terminated in response to call release by the calling subscriber, and MRFP resources are released. It is also possible that the MMTel-AS terminates the connection with the message recording system, e.g. when a message being recorded by the calling subscriber exceeds a maximum time duration and/or data amount.

The step of controlling the recording process can include providing, by the MMTel-AS, a service script to the MRF (e.g. to the MRFC), for instance using Voice Extended Markup Language (XML).

Optionally, the method further includes placing the reference to the recorded message in a call log associated with the called subscriber. This provides the advantage that the called subscriber can find easy reference to the recorded message.

Optionally, the telephony server sends an indication that a message has been recorded towards the called subscriber. This provides the advantage that the called subscriber is informed of the fact that a message has been recorded, so that the called subscriber can attend to the message.

The recorded message includes one or more of a voice message, a video message, a text message and an image message. The message recording system can record a plurality of messages during the media connection with the calling subscriber. This provides the advantage that the message recording system can record multiple messages, e.g. of different types. The recording system can e.g. record a voicemail message and a photograph simultaneously.

### BRIEF DESCRIPTION OF THE DRAWINGS

The invention will now be further elucidated by means of non-limiting examples referring to the drawings, in which

FIG. 1 depicts a prior art network deployment;

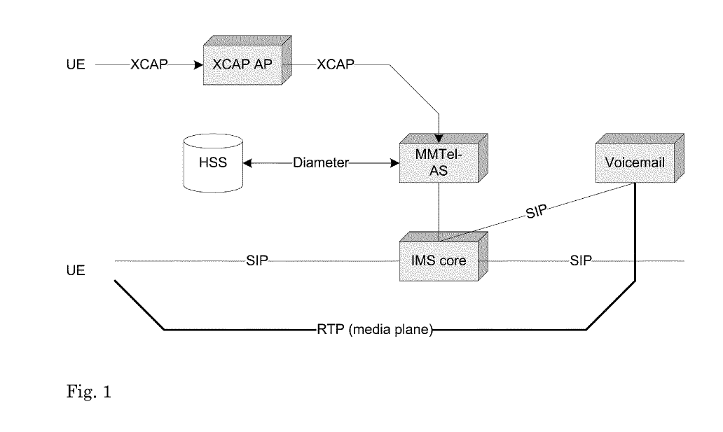

FIG. 2 is an embodiment of a system;

FIG. 3 is a schematic flow chart; and

FIG. 4 is a rudimentary architecture representation.

### DETAILED DESCRIPTION

The detailed description refers to voicemail by way of example. All aspects of the invention are equally applicable to other message recording services, such as videomail.

It is observed that current voicemail systems are not only ‘voice oriented’ (as their name implies), but they are also grafted on many fundamental principles of the Global System for Mobile Communications (GSM)/Third Generation (3G) network, such as:
a subscriber has a single terminal (the GSM/3G terminal);
a subscriber has single identity (the Mobile Station Integrated Services Digital Network (MSISDN) number);
the user plane of a call cannot be changed; that is to say, a voice call cannot be turned into a video call and vice versa.

The voicemail system is traditionally a network component that is separate from the telephony server. This implies practically that:
in a GSM/3G network, the voicemail system is a network component external to the Mobile Switching Centre (MSC);
in a Multimedia Telephony (MMTel) network, the voicemail system is a network component external to the MMTel Application Server (MMTel-AS).

In such traditional systems, there is no functional connection between the MSC or the MMTel-AS and the voicemail system, other than that the MSC or the MMTel-AS forwards a call, destined for the called subscriber, to the voicemail system if the call towards the called subscriber cannot be established. The forwarding destination forms part of the called subscriber's telephony service profile. The MSC or the MMTel-AS generally handles forwarding to the voicemail system in identical manner to forwarding to an arbitrary other destination, such as a different subscriber.

Once the call has been forwarded to the voicemail system, the MSC or the MMTel-AS has no further control over that call, other than that it applies charging for that call (such as generating charging records) and that it may tear down the call.

Third Generation Partnership Project (3GPP) specifications such as 3GPP TS 24.229 (IP multimedia call control protocol based on SIP (Session Initiation Protocol) and SDP (Session Description Protocol); Stage 3) and 3GPP TS 26.404 (Communication Diversion (CDIV) using IP Multimedia (IM) Core Network (CN) subsystem; Protocol specification) assume that the voicemail system is an external system. An incoming communication session may be forwarded to the external voicemail system, as described above.

The fact that the MMTel-AS has no further control over the call, once the terminating call has been forwarded to the voicemail system in prior art communications networks, is at least partially responsible for the above mentioned disadvantages.

The present description describes examples that overcome the aforementioned shortcomings. More specifically, the examples demonstrate solutions and methods that allow for integration of voicemail processing and multimedia service logic processing. This can allow for building a meta service, whereby multimedia telephony and voicemail can control and augment one another. The examples also allow for providing more transparent network architecture, comprising fewer nodes and fewer databases, with simplified subscriber data structure and fewer subscriber data provisioning and self-administration points.

There is potential for a relation between and interaction between the basic telephony server and the voicemail system. This relation and interaction is in two directions:

1) the (intermediate) outcome of the service processing of the voicemail system serves as input for certain basic telephony services; and
2) the (intermediate) outcome of the service processing of the basic telephony service serves as input for certain voicemail system services.

An example of 1) is the following: the result of connecting the calling subscriber to the voicemail system, namely whether or not a voicemail message was deposited, shall be reflected in the call log. The call log is a feature that forms part of basic telephony handling, especially in contemporary Internet Protocol Multimedia Subsystem (IMS) based telephony, such as MMTel.

An example of 2) is the following: when a calling subscriber is connected to the voicemail system, the called subscriber may want to break into the voicemail connection, e.g. to answer the call (because he/she was just too late to pick up the phone). Such service capability would benefit from more intimate functional connection between the MMTel-AS and the voicemail system.

However, such (and other) intimate interworking between the MMTel service logic processing and the voicemail service logic processing cannot be realized with prior art systems, due to the fact that MMTel and voicemail are being implemented in and operated in separate systems.

Now a description will be given of an example of a system according to the invention.

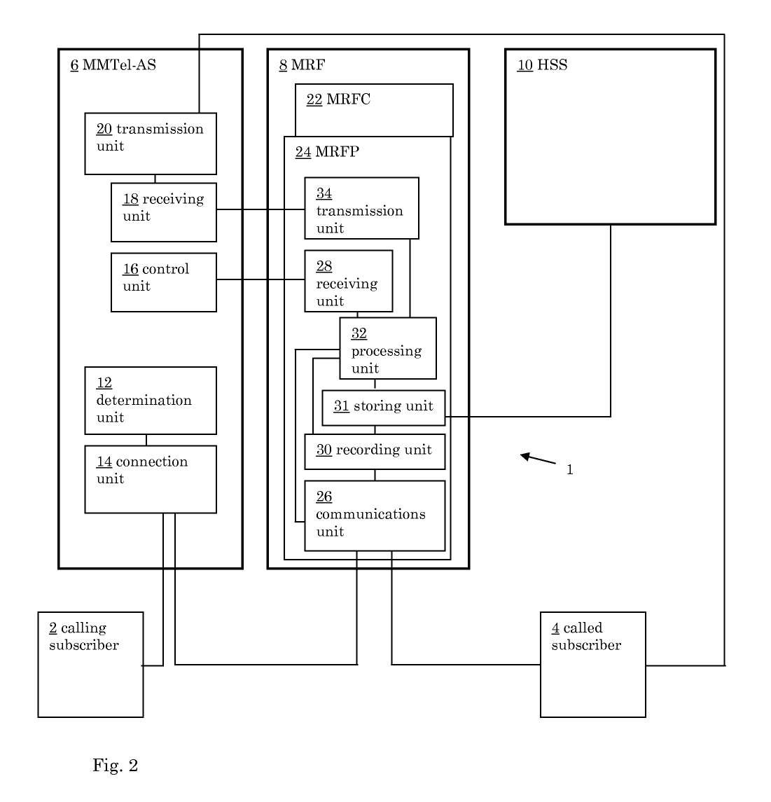

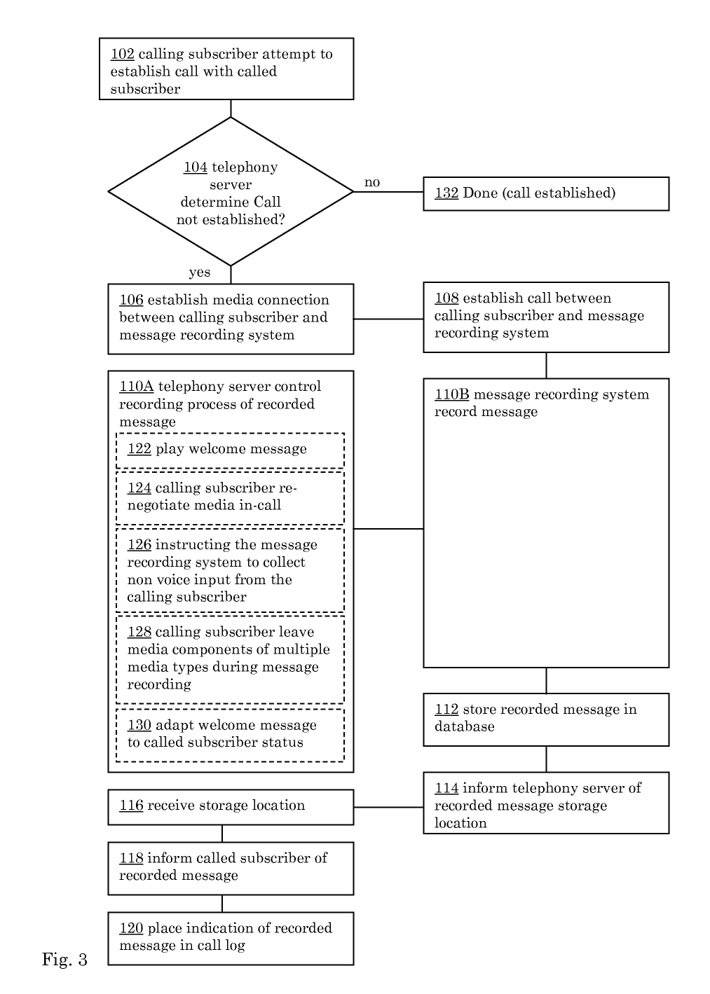

FIG. 2 shows an example of a telephony server system 1 for handling a call from a calling subscriber 2 towards a called subscriber 4. FIG. 3 shows an example of a flow chart. The telephony server system 1 includes a telephony server 6 and a message recording system 8. The called subscriber 4 is associated with the telephony server 6. The called subscriber has a subscription with an operator operating the telephony server 6.

As shown in FIG. 3, the calling subscriber 2 attempts 102 to establish a call with the called subscriber 4.

The telephony server 6 includes a determination unit 12 arranged for determining whether the call is answered by a user equipment (UE) of the called subscriber 4. When the determination unit 12 determines 104 that the call is not answered by the called subscriber 4, the telephony server 6 establishes 106 a media connection between the calling subscriber 2 and the message recording system 8. Thereto, the telephony server 6 includes a connection unit 14 arranged for establishing said media connection. The message recording system 8 includes a communications unit 26 arranged for establishing 108 the media connection with the calling subscriber 2.

When the call is not answered by a user equipment of the called subscriber 4, and the media connection between the calling subscriber 2 and the message recording system 8 has been established, the message recording system 8 can record 110B a message, such as a voicemail message. Thereto, the message recording system 8 includes a recording unit 30. The message recording system further includes a storing unit 31 arranged for storing 112 the recorded message in a database 10 associated with the message recording system 8.

The telephony server 6 established the media connection between the calling subscriber 2 and the message recording system 8. The telephony server, however, retains control of the recording process. Thereto, the telephony server 6 includes a control unit 16 arranged for controlling 110A a recording process of a message by the message recording system 8. The message recording system 8 includes a receiving unit 28 arranged for receiving control instructions from the telephony server 8. The message recording system further includes a processing unit 32 arranged for processing the control instructions, and for controlling the recording unit 30 accordingly. The message recording system 8 also includes a transmission unit 34 arranged for transmitting 114 to the telephony server 6 a reference to the recorded message, such as a location of the recorded message in the database 10. The telephony server further includes a receiving unit 18 arranged for receiving 116 the reference to the recorded message from the message recording system 8.

Hence, the telephony server 6 retains control over the call while the message recording system 8 records the message. This allows interaction between the telephony server 6 and the message recording system 8 during recording of the message.

The step of controlling 110A the recording process of the message by the message recording system 8, can include one or more of
the telephony server 6 controlling the playing 122 of a welcome message by the message recording system 8;
the telephony server allowing the calling subscriber to re-negotiate 124 the media type during the call;
the telephony server instructing the message recording system to collect 126 non-voice input from the calling subscriber;
the telephony server allowing the calling subscriber 2 to leave (step 128) media components of multiple media types during message recording; and
the telephony server 6 adapting 130 the welcome message to a current status of the called subscriber 4.

In an embodiment, the telephony server 6 further informs the called subscriber 4 of the recorded message, e.g. transmits a message to the called subscriber that a message has been recorded. Alternatively, or additionally, the telephony server 6 places an indication of the recorded message in a call log of the called subscriber 4.

In the example of FIG. 2, the telephony server 6 is an MMTel-AS. In this example the message recording system 8 is a Media Resource Function (MRF). In this example the database is included in a Home Subscriber Server (HSS).

Connecting the calling subscriber 2 to voicemail, or other message recording service, is a subscribed service which forms part of the MMTel service profile. The MMTel service profile is transparently stored in a HSS. Hence, the subscriber can use Extended Markup Language (XML) configuration access protocol (XCAP) based service administration for the MMTel service profile.

The MMTel-AS 6 offers the subscribers the capability to administer one's telephony service through the exchange of XML documents, which are transferred through XCAP over Hypertext Transfer Protocol (HTTP) (Ut reference point between the UE and the MMTel-AS 6). An MMTel terminal, e.g. a Voice over Long Term Evolution (VoLTE) terminal, can have a graphical user interface allowing the subscriber to navigate through the service options (in the user profile). When a vendor's MMTel implementation is enhanced with functionality that goes beyond 3GPP standard MMTel, the capability of the XCAP signalling can be enhanced accordingly. In that manner, the subscriber gets a consolidated service view for administering his/her profile. This consolidated service view can comprise functionality related to the forwarding to the message recording system. In particular, this can relate to functionality that relates to a service that integrates telephony and voicemail.

When a call towards a called subscriber 4 (e.g. an MMTel subscriber) fails (considering multiple devices on which the call may have been offered), the MMTel-AS 6 diverts the SIP Invite request to a Media Resource Function Controller (MRFC) 22 in the IMS network, for applying user interaction. The user interaction can include the playing of an announcement, the collecting of user input (e.g. non-voice input such as key presses) and the recording of a voicemail message.

The MRFC 22 uses Voice XML to obtain a service script from the MMTel-AS 6. Usage of Voice XML between an MRFC and a SIP application server (SIP-AS) is a common and well-defined methodology.

Standard SIP signalling, e.g. according to IETF Standard, is used for SDP offer-answer exchange between the calling subscriber 2 and the MRFC 22.

It is also possible that MRFC functionality is included in the MMTel-AS 6. In that case, the MMTel-AS 6 allocates and controls the Media Resource Function Processor (MRFP) 24 directly, without separate MRFC 22. The MMTel-AS 6 uses H.248 towards the MRFP 24.

The user plane connection between the calling subscriber 2 and the message recording system 8 is established between the calling subscriber 2 and the MRFP 24. This is the MRFP 24, in message recording system 8, seized by and controlled by the MRFC 22 or the MRFP 24 controlled directly by the MMTel-AS 6.

When the calling subscriber 2 releases the call, the SIP session with the MRFC 22 is terminated by the MMTel-AS 6; the MRFP 24 resources are released. The MRFP 24 stores the recorded message in the database 10. In this example the database is included in the HSS. The MRFP 24 provides a reference (e.g. File Transfer Protocol (FTP) address) to this recorded message to the MRFC 22, which provides the reference to the MMTel-AS 6 (e.g. in the 200 Ok following the Bye request from MMTel-AS). This reference to the stored recorded message in the HSS 10 is placed in the call log.

The MMTel-AS 6 can send a SIP Message towards the called subscriber 4, on whose behalf the message recording service is being executed. This SIP Message can be sent via the Internet Protocol Short Message (IP-SM) Gateway, which may store the message if needed. Such sending of a SIP Message to the called subscriber is used for recorded message indication.

In this manner, through intrinsic enhancement in the MMTel service logic, the MMTel-AS can have control of the message recording, such as voicemail recording. This allows for intricate interworking between telephony and message recording (voicemail), as described in the few examples above. However, more advanced interworking cases will be facilitated by this method.

The communication session established between the calling subscriber 2 and the message recording system 8 under control of the MMTel-AS 6 can use features like:
In-call media re-negotiation, e.g. change from voice call to video call. The calling subscriber 2 may decide, whilst having a voicemail message recorded by the message recording system 8, to switch to video. The resulting SIP signaling for the voice-to-video change is handled, as normal, by the MMTel-AS 6. The MMTel-AS relays the SDP re-negotiation to the MRFC 22, which may instruct the MRFP 24 to allocate video resources and to start video mail recording. In this case, the message recording system 8 records two messages. The first message is the message recorded prior to the media change, the second message is the message recorded after the media change. In such case, the message recording system 8 can provide, to the telephony server 6, a reference to the first message after recording the first message and a reference to the second message after recording the second message. The reference to the first message can be transmitted to the telephony server 6 prior to or during recording of the second message. Alternatively, the message recording system provides multiple references (e.g. one for each recorded message) at the end of recording both messages.
Start a chat session during the call. Whilst leaving a voicemail (or video message), the calling subscriber 2 can enter a text messages. The text messages will be recorded with the voicemail message or as a separate recorded message. This is ‘one-way chat’.

File share. Whilst leaving a voicemail or video message, the calling subscriber 2 can send a picture or other file to the called subscriber's message recording system 8. The picture is then kept with the voicemail. The reference to the picture can contain a reference to the accompanying voice or video message. Such functionality can be done through Rich communication suite (RCS).

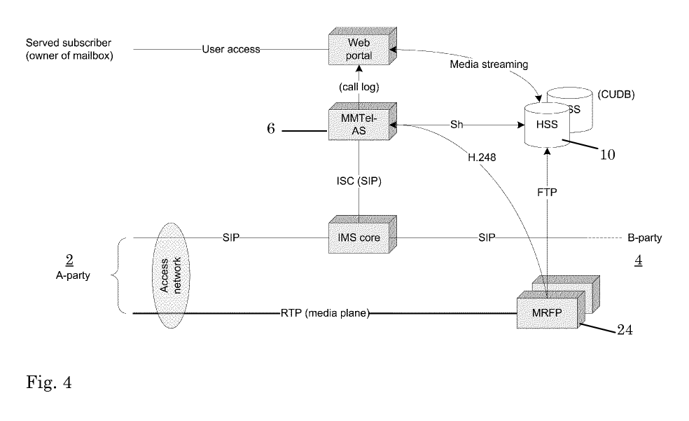

FIG. 4 gives a rudimentary architecture representation of an embodiment of the proposed system.

The MMTel-AS 6 uses H.248 signaling towards an MRFP 24 that it has selected for handling a voicemail service for a subscriber (the called subscriber 4 for whom the call establishment has failed). There can be a plurality of MRFPs 24 in the network. The H.248 signaling is used by the MMTel-AS 6 to provide instructions to the MRFP 24 to establish a media session between the calling subscriber 2 and the MRFP 24, to play an announcement, to record a voicemail etc. . . . The H.248 signaling is also used by the MRFP 24 to provide the MMTel-AS 6 with the reference to the voicemail file that it has stored in the HSS 10.

FTP is used between the MRFP 24 and the HSS 10, to store the recorded voicemail file. Assuming that the HSS 10 is deployed with a layered architecture (HSS front-end and Centralised User Database (CUDB)), the MRFP 24 can use FTP towards any of the available HSS 10 front-ends. The voicemail recording does not have to be stored in a data record directly associated with the served subscriber. The voicemail recording can be stored in a dedicated database in the CUDB that is specific for voicemail recordings, i.e. not specifically in the HSS application on the CUDB. The MRFP 24 returns, via H.248, a reference to the stored file. The reference to that file is placed in the call log of the subscriber. In that manner, the functional connection is provided between subscriber data (the call log) and the voicemail recording.

The MMTel-AS writes the result of the voicemail recording into the call log. Specifically, the call log contains (i) an indication that the incoming call was forwarded to voicemail, (ii) an indication that a voicemail/videomail message was deposited and (iii) a hyperlink to stream that voicemail.

It will be appreciated that the determination unit 12, the connection unit 14, the control unit 16, the receiving unit 18, the transmission unit 20, the communications unit 26, the receiving unit 28, the recording unit 30, the storing unit 31, the processing unit 32 and/or the transmission unit 34 can be embodied as dedicated electronic circuits, possibly including software code portions. The determination unit 12, the connection unit 14, the control unit 16, the receiving unit 18, the transmission unit 20, the communications unit 26, the receiving unit 28, the recording unit 30, the storing unit 31, the processing unit 32 and/or the transmission unit 34 can also be embodied as software code portions executed on, and e.g. stored in a memory of, a programmable apparatus such as a computer.

The integration of message recording with the telephony service, e.g. voicemail/videomail with the MMTel-AS, provides the possibility to build services that combine call handling and voicemail functionality. Advantageous examples include:
call log; the result of the connection to voicemail (message deposited, no message deposited) can easily be included in the call log.
toll-free welcome message; although this feature would be possible with external voicemail system already, the MMTel server can now accurately determine when the charging of the connection to voicemail shall start, after a toll-free welcome message.
toll-free user input, such as non-voice user input e.g. key stroke or touch input, before voice recording; the MMTel server can apply the Early media authorization method (′P-early-media′) to obtain user input (in the form of key presses or touch input) prior to starting the charge of the calling subscriber.
re-attempt connecting to the called subscriber whilst recording; it can occur that the calling subscriber is connected to voicemail due to the called subscriber being busy. Whilst voicemail recording is ongoing, the called subscriber becomes available (e.g. has terminated the ongoing conversation). The MMTel-AS can now interrupt the ongoing voicemail recording by the calling subscriber and prompt the calling subscriber that the call to the called subscriber can be re-attempted. The calling subscriber can indicate, e.g. through key press, whether (s)he wants the call to the called subscriber to be re-attempted or whether (s)he wants to continue (or re-start) recoding voicemail message.
Voicemail welcome message can be adapted to subscriber current state and location. The MMTel-AS has knowledge about the state and location of the called subscriber and can adapt the voicemail welcome message accordingly. For example, a voicemail welcome announcement can be adapted to an Outlook calendar state; the welcome message informs the calling subscriber about the time when the called subscriber will be available again.
Call barge-in; barge-in is an existing method, whereby a person can ‘break into’ an ongoing call. For example, a secretary can break into an ongoing call from her manager, when this is deemed required and appropriate for the message she has for her manager.

When a call is established to a person and the person is busy (in a call), then the calling party can be offered ‘barge-in opportunity’ before being connected to voicemail; the calling party is prompted to enter the barge-in code. Entering the barge-in code results in the call to break into the called party's ongoing call.
A subscriber's dynamic MMTel service data contains an indication about messages that the subscriber has not yet listened to. When the subscriber establishes a call, (s)he may get an audible indication about this. For example, when the subscriber calls a particular person and there is a voicemail recording from that person that the subscriber has not listened to yet, the subscriber is offered the opportunity to first listen to this voicemail.
When a person deposits a voicemail, that person is offered the option to receive a notification, e.g. through Instant Message or SMS, that the called subscriber has actually listened to that voicemail message.

It is observed that these service capabilities are facilitated through integration of voicemail and Basic telephony. These services would predominantly not be feasible with an external voicemail server, i.e. a voicemail server that is not integrated in basic telephony service.

The method proposed in the present document is described for IMS based telephony, i.e. Multimedia telephony. The method could also be applied to Circuit Switched (CS) based telephony, such as GSM/3G. It shall further be borne in mind that the solution is described within an IMS and MMTel context. The solution is, however, also applicable for a Voice over IP (VOIP) solution, for example, a SIP based Call server (operating in a non-IMS IP communication network). The solution described in the present document can also be considered for an Enterprise communication service.

The description of the invention refers generally to voicemail. All aspects of the invention are equally applicable to videomail.

In the foregoing specification, the invention has been described with reference to specific examples of embodiments of the invention. It will, however, be evident that various modifications and changes may be made therein without departing from the broader spirit and scope of the invention as set forth in the appended claims.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to advantage.

1-15. (canceled)

16. A method for handling a call from a calling subscriber towards a called subscriber associated with a telephony server in a communications network, comprising:
when the call is not answered by a user equipment of the called subscriber, establishing, by the telephony server, a media connection between the calling subscriber and a message recording system;
controlling, by the telephony server, a recording process of a message by the message recording system; and
receiving, by the telephony server, from the message recording system a reference to the recorded message.

17. The method according to claim 16, further comprising placing the reference to the recorded message in a call log associated with the called subscriber.

18. The method according to claim 16, further comprising sending, by the telephony server, towards the called subscriber an indication that the message has been recorded.

19. The method according to claim 16, wherein controlling the recording process comprises one or more of:
instructing the message recording system to play an announcement;
instructing the message recording system to collect non-voice input from the calling subscriber; and
instructing the message recording system to initiate or accept in-call media re-negotiation to the calling subscriber.

20. The method according to claim 16, wherein the called subscriber is a Multimedia Telephony (MMTel) subscriber, the communications network is an Internet Protocol Multimedia Subsystem (IMS) communications network, the telephony server is an MMTel Application Server (MMTel-AS) and the message recording system is a Media Resource Function (MRF), wherein establishing the media connection comprises one of:
sending, by the MMTel-AS, a Session Initiation Protocol (SIP) Invite request relating to the call to the MRF; and
controlling, by the MMTel-AS, media resources in the MRF through H.248 signalling;
wherein receiving the reference comprises receiving, from the MRF, the reference to a storage location of the recorded message in a database.

21. The method according to claim 20, wherein the database is a Home Subscriber Server (HSS) or Centralized User Database (CUDB).

22. The method according to claim 20, wherein controlling the media references comprises providing instructions to a Media Resource Function Processor (MRFP) for establishing a user plane connection between the calling subscriber and the MRFP,
wherein the method further comprises storing, by the MRFP, the recorded message in the database; and
wherein receiving the reference comprises receiving, by the MMTel-AS, the reference to the storage location from the MRFP.

23. The method according to claim 22, wherein controlling the media references comprises providing, by the MMTel-AS, a service script to the MRF.

24. A telephony server for handling a call from a calling subscriber towards a called subscriber associated with the telephony server in a communications network, the telephony server comprising:
a determination circuit configured to determine whether the call is answered by a user equipment of the called subscriber;
a connection circuit configured to, when the determination circuit has determined that the call has not been answered by the user equipment, establish a media connection between the calling subscriber and a message recording system;
a control circuit configured to control a recording process of a message by the message recording system; and
a receiving circuit configured to receive from the message recording system a reference to the recorded message.

25. The telephony server according to claim 24, wherein the control circuit is configured to provide a service script to the message recording system.

26. The telephony server according to claim 24, further comprising a transmission circuit configured to send an indication towards the called subscriber that a message has been recorded.

27. The telephony server according to claim 24, wherein the control circuit is configured to do one or more of the following operations:
instruct the message recording system to play an announcement;
instruct the message recording system to collect non-voice input from the calling subscriber; and
instruct the message recording system to initiate or accept in-call media re-negotiation to the calling subscriber.

28. A message recording system for use in a communications network, the message recording system comprising:
a communications circuit configured to establish a media connection with a subscriber;
a receiving circuit configured to receive control instructions from a telephony server;
a recording circuit configured to record a message;
a storing circuit configured to store the message in a database associated with the message recording system;
a processing circuit configured to process the control instructions, and control the recording circuit accordingly; and
a transmission circuit configured to transmit to the telephony server a reference to the recorded message.

29. A telephony server system comprising:
a telephony server configured to handle a call from a calling subscriber towards a called subscriber associated with the telephony server in a communications network, the telephony server comprising:
a determination circuit configured to determine whether the call is answered by a user equipment of the called subscriber;
a connection circuit configured to, when the determination circuit has determined that the call has not been answered by the user equipment, establish a media connection between the calling subscriber and a message recording system;
a control circuit configured to control a recording process of a message by the message recording system; and
a receiving circuit configured to receive from the message recording system a reference to the recorded message; and
the message recording system, comprising:
a communications circuit configured to establish the media connection with the calling subscriber;
a receiving circuit configured to receive control instructions from the telephony server;
a recording circuit configured to record the message;
a storing circuit configured to store the message in a database associated with the message recording system;
a processing circuit configured to process the control instructions, and control the recording circuit accordingly; and
a transmission circuit configured to transmit to the telephony server the reference to the recorded message.

30. The telephony server system according to claim 29, wherein the telephony server is a Multimedia Telephony Application Server (MMTel-AS) and the message recording system is a Media Resource Function (MRF).
